(19) United States
(12) Patent Application Publication
(10) Pub. No.: US 2022/0360438 A1
(43) Pub. Date: Nov. 10, 2022

(54) SECURITY DEVICE AND SECURITY PROGRAM

(71) Applicant: PSDL, Seongnam-si (KR)

(72) Inventors: Sungwoo CHUN, Gimpo-si (KR); Deok Soo HWANG, Suwon-si (KR)

(21) Appl. No.: 17/871,572

(22) Filed: Jul. 22, 2022

Related U.S. Application Data
(63) Continuation of application No. PCT/KR2021/000964, filed on Jan. 25, 2021.

(30) Foreign Application Priority Data
Jan. 23, 2020 (KR) 10-2020-0009136
Dec. 14, 2020 (KR) 10-2020-0174605
Jan. 21, 2021 (KR) 10-2021-0008713

(51) Int. Cl. H04L 9/08; G06F 7/58

(52) U.S. Cl. CPC H04L 9/0869; G06F 7/588

(57) ABSTRACT

A security device is provided. The security device includes: a communication antenna for receiving a communication signal; and a random number generator for newly generating a random number based on the communication signal received in the communication antenna.

### CROSS-REFERENCE TO RELATED APPLICATIONS

This application is a continuation of Application No. PCT/KR2021/000964 filed on Jan. 25, 2021, which in turn claims the benefit of Korean Patent Applications No. 10-2020-0009136 filed on Jan. 23, 2020, 10-2020-0174605 filed on Dec. 14, 2020, and 10-2021-0008713 filed on Jan. 21, 2021, the disclosures of which are incorporated by reference into the present application.

### TECHNICAL FIELD

The present invention relates to a security device, and more specifically, to a security device for generating a physical random number based on a communication signal.

### BACKGROUND ART

Personal security is becoming important day by day. This is because basic information of an individual daily life is stored in portable electronic devices, bills are received through a webmail, important personal information is accessed through public certificates, and money is deposited in and withdrawn from accounts through OTP.

In the era of the 4th industrial generation, the importance of security is expected to grow. Therefore, the importance of random numbers serving as key elements of security is also growing. According to Wikipedia, a random number (an unpredictable random array of numbers) refers to a number that is randomly selected within a defined range, where no one can be sure what will come next.

Security is an important factor in communication, and since the Internet of Things is expected to dramatically increase in the era of the 4^{th} industrial generation, the need for random numbers is expected to increase significantly compared to the past.

Random numbers are absolutely necessary to maintain the security framework of the security system, and so far, the security framework has been established using pseudo (fake) random numbers generated by computer software. The pseudo-random number method has been introduced into most security devices and systems because of the advantage that random numbers can be generated very easily and at high speed.

However, due to the rapid development of computer performance (for example, the advent of supercomputers), the security framework that is set with pseudo-random numbers has the disadvantage that it can be easily hacked in the near future because it is easy to predict and censor the generated random numbers from the outside.

In order to overcome these limitations and secure the security in the era of the 4^{th} industrial generation, researchers around the world are continuously developing a physical (real) security device for generating random numbers from physical phenomena that no one can predict.

### DISCLOSURE

### Technical Problem

One technical object of the present invention is to provide a security device for generating a physical random number based on a communication signal.

The technical object of the present invention is not limited to the above.

### Technical Solution

In order to achieve the one technical object, the present invention provides a security device.

According to one embodiment, the security device may include: a communication antenna for receiving a communication signal; and a random number generator for newly generating a random number based on the communication signal received in the communication antenna.

According to one embodiment, the security device may further includes a control unit, wherein the control unit may transmit the random number to an electronic device through the communication antenna so that information stored in the electronic device, which is connected to the control unit for communication, is encrypted based on the random number.

According to another embodiment, the security device may further includes a memory and a control unit, wherein the control unit may include: an encryption key generator for generating an encryption key using the random number generated by the random number generator; and an encryption unit for encrypting information stored in the memory using the generated encryption key, and wherein, when the information is requested from the electronic device connected to the control unit for communication, the control unit may generate the encryption key by using the random number provided from the random number generator through the encryption key generator, encrypt the information through the encryption unit, and transmit the encrypted information and the generated encryption key to the electronic device through the communication antenna.

According to still another embodiment, the security device may further include a memory and a control unit, wherein the memory may further store a server encryption key, and the control unit may include: an encryption key generator configured to generate a device private encryption key (PaDevice) using the random number generated from the random number generator, generate a device public encryption key (PuDevice) based on the device private encryption key (PaDevice), and generate a shared encryption key (S Key) by using one of the device private encryption key (PaDevice) and the device public encryption key (PuDevice), and the server encryption key; and an encryption unit configured to encrypt information stored in the memory using the generated shared encryption key (S Key), and wherein, when the information is requested from the electronic device connected to the control unit for communication, the control unit may generate the device private encryption key (PaDevice), the device public encryption key (PuDevice), and the shared encryption key (S Key) using the random number provided from the random number generator through the encryption key generator, encrypt the information with the shared encryption key (S Key) through the encryption unit, and transmit the encrypted information and the generated device public encryption key (PuDevice) to the electronic device through the communication antenna, and wherein the server encryption key may be any one of a server private encryption key (PaSever) and a server public encryption key (PuServer).

According to still another embodiment, any one of the electronic device and the external electronic device that manages the information provided from the electronic device may utilize the server encryption key stored in the memory and the device public encryption key (PuDevice) to decrypt the encrypted information.

According to still another embodiment, the encryption key generator may be configured to refresh the device private encryption key (PaDevice) using the newly generated random number so that the shared encryption key (S Key) may be continuously regenerated.

According to still another embodiment, the server encryption key may be pre-stored before decryption in any one of the electronic device and an external electronic device that manages information provided from the electronic device.

According to one embodiment, the communication signal may include a communication signal transmitted through any one or at least two of communication networks including Wi-Fi, mobile communication, RF, Zigbee, LoRa, and Bluetooth.

According to one embodiment, the security device may be integrally provided with any one communication module selected from communication modules including a Wi-Fi module, a mobile communication module, an RF module, a Zigbee module, a LoRa module, and a Bluetooth module.

A security program according to one embodiment of the present invention may be stored in a medium for performing the steps of: generating a random number based on a radio frequency (RF) signal from an external electronic device; encrypting data using the generated random number; and transmitting the encrypted data to an external electronic device.

A security device according to one embodiment of the present invention may include a communication antenna for receiving a communication signal; an encryption unit for encrypting data with an encryption key; and a control unit for transmitting encrypted data to an external electronic device through the communication antenna, wherein the encryption key of the encryption unit and the encryption key used by the external electronic device to decrypt the encrypted data may be derived from different source keys, and the source key of the encryption key of the encryption unit may not be transmitted to the external electronic device.

According to one embodiment, the encryption unit may further include a random number generator for generating a random number used to generate the encryption key based on the communication signal received in the communication antenna, and wherein the random number and the encryption key may be refreshed according to time as the received communication signal varies.

According to one embodiment, the encryption unit may further include an encryption key generator for generating a sensor private encryption key (Priv_sender) based on the random number generated by the random number generator, and generating a public encryption key (Pub_sender) from the private encryption key (Priv_sender), and wherein the private encryption key (Priv_sender) and the public encryption key (Pub_sender) may have a planar relationship where the public encryption key (Pub_sender) is generated based on the private encryption key (Priv_sender), and the private encryption key (Priv_sender) is not generated based on the public encryption key (Pub_sender).

According to one embodiment, the security device may further include a memory for storing a public encryption key (Pub_receiver) of the external electronic device, wherein a source key used by the encryption key generator to generate the encryption key may include the public encryption key (Pub_receiver) of the external electronic device stored in the memory and the private encryption key (Priv_sender) generated by the encryption key generator.

According to one embodiment, the control unit may further transmit the public encryption key (Pub_sender) to the external electronic device through the communication antenna, the external electronic device may store a private encryption key (Priv_receiver) used to generate the public encryption key (Pub_receiver) of the external electronic device, and a source key of the encryption key used by the external electronic device to decrypt the received encrypted data may include the private encryption key (Priv_receiver) of the external electronic device and the received public encryption key (Pub_sender).

According to one embodiment, the control unit may generate energy based on the communication signal received through the communication antenna, and generate the encryption key using the generated energy.

According to one embodiment, a security program may be stored in a medium for performing the steps of: generating a random number based on a radio frequency (RF) signal from an external electronic device; generating a private encryption key (Priv_Sender) from the random number; generating a public encryption key (Pub_Sender) from the private encryption key (Priv_Sender); generating a first shared encryption key from the private encryption key (Priv_Sender) and the public encryption key (Pub_Receiver) of the external electronic device that receives encrypted data; and encrypting data with the shared encryption key and transmitting the data together with the public encryption key (Pub_Sender).

According to one embodiment, a security program may be stored in a medium for performing the steps of: receiving data encrypted with the shared encryption key according to claim 17 and the public encryption key (Pub_Sender); generating a second shared encryption key identical to the first shared encryption key from the private encryption key (Priv_Receiver) of the external electronic device and the received public encryption key (Pub_Sender); and decrypting the encrypted data with the second shared encryption key.

### Advantageous Effects

According to one embodiment of the present invention, a security device may include a communication antenna for receiving a communication signal; and a random number generator for newly generating a random number based on the communication signal received in the communication antenna.

Accordingly, a security device for generating a physical random number that no one can predict may be provided.

In addition, according to one embodiment of the present invention, information transmitted between electronic devices can be encrypted through any one of a symmetric key algorithm and an asymmetric key algorithm based on the generated random number, so that the security of the electronic device can be improved. Thus, it is possible to build a security framework, which is safe against hacking or can keep the hacking risk to the lowest level, in the communication network environment.

A security device according to one embodiment of the present invention may include: a communication antenna for receiving a communication signal; an encryption unit for encrypting data with an encryption key; and a control unit for transmitting encrypted data to an external electronic device through the communication antenna, wherein the encryption key of the encryption unit and the encryption key used by the external electronic device to decrypt the encrypted data are derived from different source keys, and the source key of the encryption key of the encryption unit is not transmitted to the external electronic device.

Even if the source key for generating the encryption key for encrypting data is different between the data transmitting terminal and the data receiving terminal, the same encryption key can be generated. Accordingly, encryption and decryption can be effectively performed even if the encryption key is not transmitted through the communication channel, so that high security and safety can be achieved.

### DESCRIPTION OF DRAWINGS

FIG. 1 is a schematic view for explaining a security device that is connected with various electronic devices for communication according to a first embodiment of the present invention.

FIG. 2 is a block diagram illustrating the security device according to the first embodiment of the present invention.

FIG. 3 is a block diagram illustrating a control unit of the security device according to the first embodiment of the present invention.

FIG. 4 is a flowchart for explaining an information encryption process of a control unit in a time series manner when information is requested by an electronic device according to the first embodiment of the present invention.

FIG. 5 is a flowchart for explaining a communication process between an electronic device and an external electronic device in a time series manner according to the first embodiment of the present invention when encrypted information is decrypted on the electronic device side.

FIG. 6 is a flowchart for explaining a communication process between an electronic device and an external electronic device in a time series manner according to the first embodiment of the present invention when encrypted information is decrypted on the external electronic device side.

FIG. 7 is a flowchart for explaining a process of transmitting encrypted information to an electronic device in a time series manner at every set time period according to the first embodiment of the present invention.

FIG. 8 is a block diagram illustrating a security device according to a second embodiment of the present invention.

FIG. 9 is a block diagram illustrating a control unit of the security device according to the second embodiment of the present invention.

FIG. 10 is a flowchart for explaining an information encryption process of a control unit in a time series manner when information is requested by an electronic device according to the second embodiment of the present invention.

FIG. 11 is a flowchart illustrating a communication process between an electronic device and an external electronic device according to the second embodiment of the present invention.

FIG. 12 is a schematic view for explaining a security device that is connected with various electronic devices for communication according to a third embodiment of the present invention.

FIG. 13 is a block diagram illustrating a security device according to the third embodiment of the present invention.

FIG. 14 is a reference view for explaining information flow between a security device, an electronic device, and an external electronic device according to the third embodiment of the present invention.

FIG. 15 is a flowchart illustrating a process of generating a random number and transmitting the random number to an electronic device in a time series manner when the random number is requested by the electronic device according to the third embodiment of the present invention.

FIG. 16 is a block diagram illustrating a security device according to a fourth embodiment of the present invention.

FIG. 17 is a block diagram illustrating a control unit of the security device according to the fourth embodiment of the present invention.

FIG. 18 is a flowchart for explaining an information encryption process of a control unit in a time series manner when information is requested by an electronic device according to one embodiment of the present invention.

FIG. 19 is a flowchart for explaining a communication process between an electronic device and an external electronic device in a time series manner according to one embodiment of the present invention when encrypted information is decrypted on the electronic device side.

FIG. 20 is a view for explaining a security program of a transmission side of encrypted data according to one embodiment of the present invention.

FIG. 21 is a view for explaining a security program of a side that receives encrypted data according to one embodiment of the present invention.

### BEST MODE

### Mode for Invention

Hereinafter, exemplary embodiments of the present invention will be described in detail with reference to the accompanying drawings. However, the technical idea of the present invention is not limited to the embodiments described herein, but may be realized in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and areas are exaggerated for efficient description of the technical contents.

In addition, in the various embodiments of the present disclosure, the terms such as first, second, and third are used to describe various elements, but the elements are not limited to the terms. The terms are used only to distinguish one element from another element. Therefore, an element mentioned as a first element in one embodiment may be mentioned as a second element in another embodiment. The embodiments described and illustrated herein include their complementary embodiments. Further, the term “and/or” used herein is used to include at least one of the elements enumerated before and after the term.

As used herein, the terms of a singular form may include plural forms unless the context clearly indicates otherwise. Further, the terms such as “including” and “having” are used to designate the presence of features, numbers, steps, elements, or combinations thereof described in the present disclosure, and shall not be construed to preclude any possibility of the presence or addition of one or more other features, numbers, steps, elements, or combinations thereof.

Further, in the following description of the present invention, detailed descriptions of known functions and configurations incorporated herein will be omitted when they may make the subject matter of the present invention unnecessarily unclear.

In the present specification, a private encryption key and a public encryption key may have a one-way relationship. The one-way relationship means that a public encryption key may be generated based on the private encryption key, but on the contrary, a private encryption key cannot be generated based on the public encryption key.

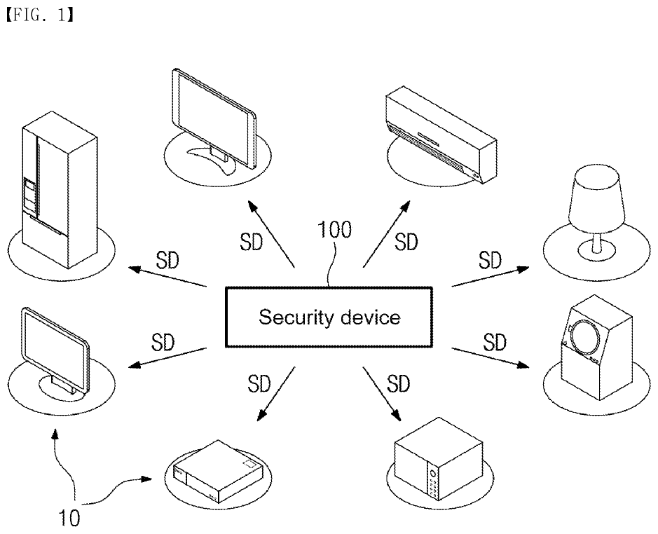

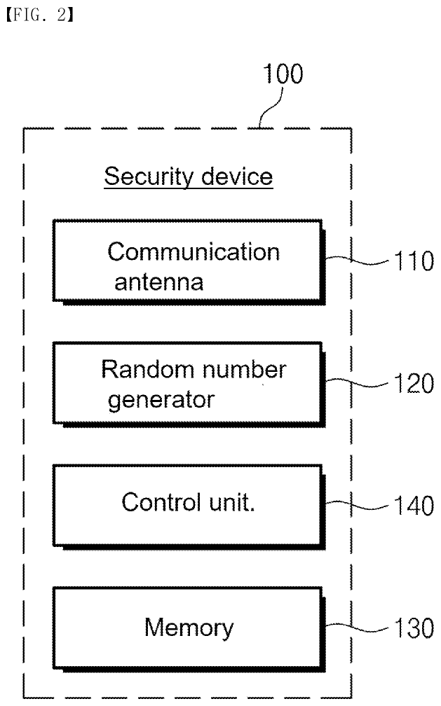

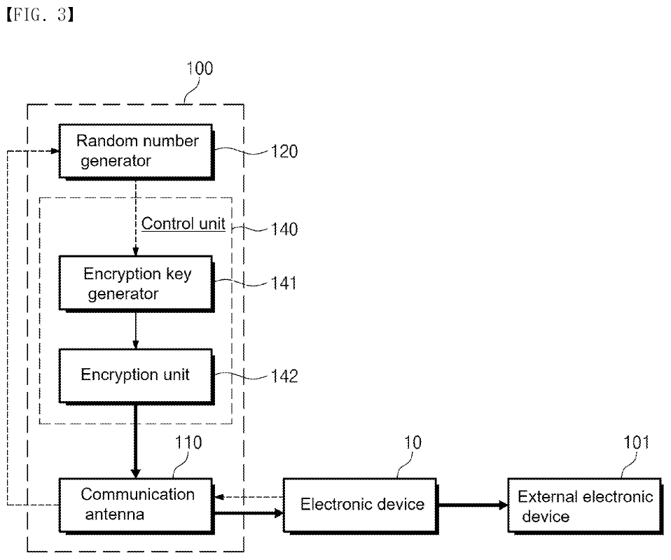

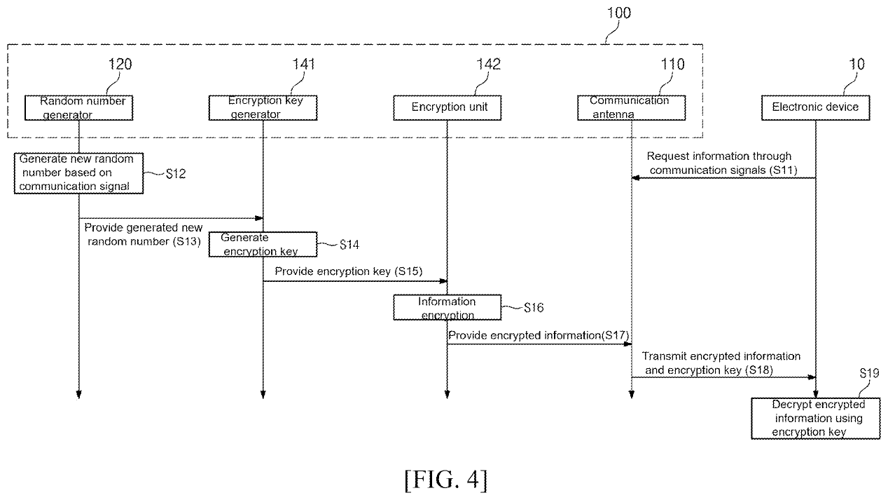

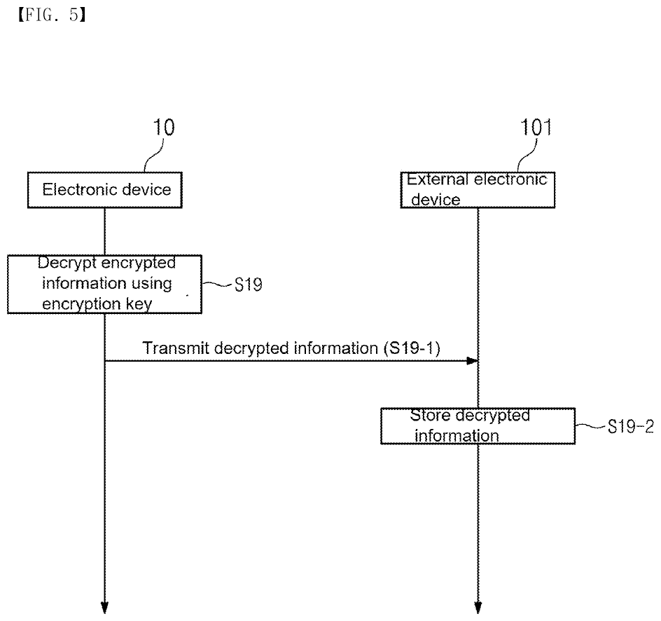

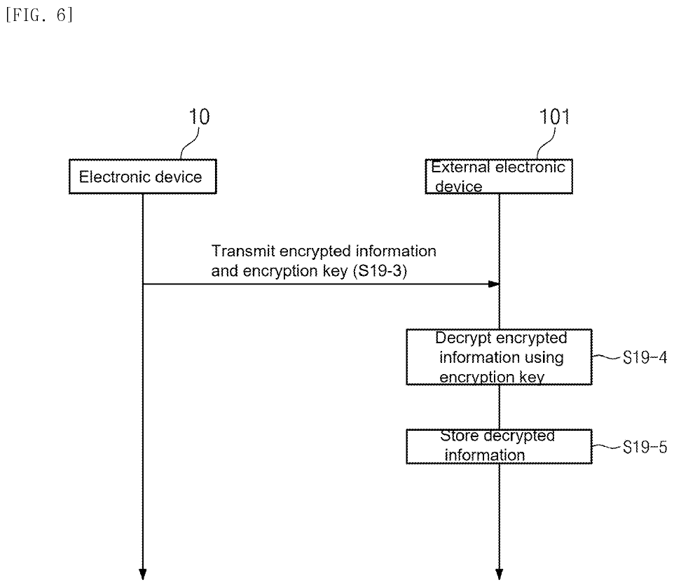

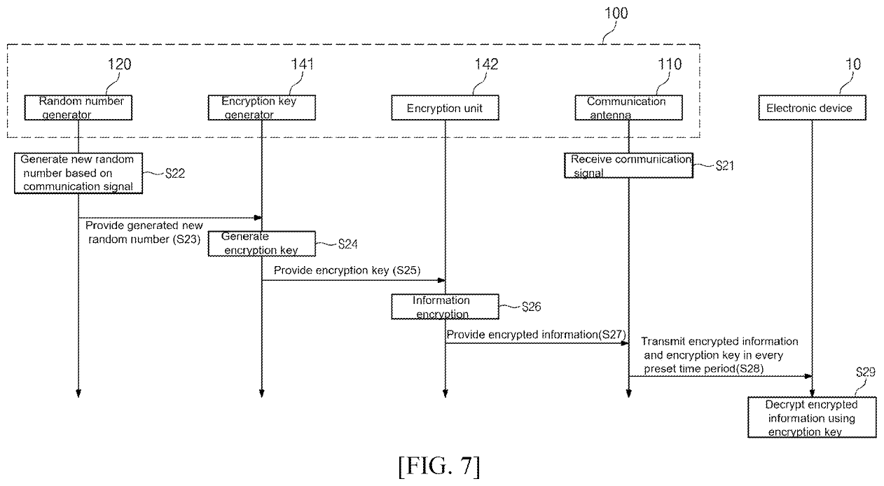

FIG. 1 is a schematic view for explaining a security device that is connected with various electronic devices for communication according to a first embodiment of the present invention, FIG. 2 is a block diagram illustrating the security device according to the first embodiment of the present invention, FIG. 3 is a block diagram illustrating a control unit of the security device according to the first embodiment of the present invention, FIG. 4 is a flowchart for explaining an information encryption process of a control unit in a time series manner when information is requested by an electronic device according to the first embodiment of the present invention, FIG. 5 is a flowchart for explaining a communication process between an electronic device and an external electronic device in a time series manner according to the first embodiment of the present invention when encrypted information is decrypted on the electronic device side, FIG. 6 is a flowchart for explaining a communication process between an electronic device and an external electronic device in a time series manner according to the first embodiment of the present invention when encrypted information is decrypted on the external electronic device side, and FIG. 7 is a flowchart for explaining a process of transmitting encrypted information to an electronic device in a time series manner at every set time period according to the first embodiment of the present invention.

As shown in FIG. 1, a security device 100 according to the first embodiment of the present invention may generate a random number that no one can predict based on a communication signal received from various electronic devices 10 that are communicatively connected on a communication network, and may encrypt information using the random number to transmit encrypted information SD to various electronic devices 10.

Accordingly, it is possible to escape from the risk of hacking and to build a communication network having an excellent security system.

In the first embodiment of the present invention, the communication signal used to generate the random number may include a wireless communication signal transmitted through any one or at least two of communication networks including Wi-Fi, mobile communication, RF, Zigbee, LoRa, Near Field Communication, and Bluetooth. However, this is only an example and any wireless signal may be used. In terms of frequency, at least one of Near-Field communication (NFC) in the band of 13.56 MHz and Radio Frequency (RF) in the band of 125 kHz, 134 kHz, 433.92 MHz, 860 to 960 MHz and 2.45 GHz may be used as a communication signal.

In addition, according to the first embodiment of the present invention, the communication signal used to generate the random number may be a wired communication signal transmitted through a wired communication network.

Further, various electronic devices 10 communicatively connected to the security device 100 according to the first embodiment of the present invention may be a communication device including a wireless communication module such as a Wi-Fi module, a mobile communication module, an RF module, a Zigbee module, a LoRa module, a Near-Field communication module (NFC module, and a Bluetooth module. It is also possible to include other communication modules.

In addition, various electronic devices 10 communicatively connected to the security device 100 according to the first embodiment of the present invention may be an Internet of Things (IoT) device or an Augmented Reality device.

As another example, various electronic devices 10 communicatively connected to the security device 1100 according to one embodiment of the present invention may be provided in the form of accessories such as rings, watches, and earrings, in the form of clothes, gloves, and shoes which are worn on a human body, and in the form of medical devices that are worn on or implanted in the human body to measure or collect biometric information such as blood pressure, electrocardiogram, and heart rate.

As another example, the security device 1100 according to one embodiment of the present invention may correspond to a device requiring secure communication. For example, the security device 1100 according to one embodiment may correspond to a walkie-talkie requiring voice security communication and a door lock allowing only authorized personnel to enter.

As still another example, the security device 1100 according to one embodiment of the present invention may be used in a device for authenticity authentication. For example, when the authenticity authentication code is stored in the security device 1100 according to one embodiment of the present invention, the authenticity or fake can be determined by receiving the authenticity authentication code from an external electronic device.

The security device 100 according to the first embodiment of the present invention may be integrally provided in any one of the various electronic devices 10. That is, the security device 100 according to the first embodiment of the present invention may form a single chip together with any one electronic device 10. For example, the security device 100 may form a single chip together with a Wi-Fi module, a Bluetooth module, and a mobile communication module.

In this manner, if the security device 100 and the communication module form a single chip, the security device 100 may generate a random number based on the communication signal of the communication module constituting the single chip, and may transmit information to other electronic devices 10 by encrypting the information based on the generated random number, so that hacking becomes difficult, and thus, a high-level security system may be established.

As another example, the security device 100 may interwork with individual electronic devices 10 as separate hardware, for example, a dongle type.

The security device 100 according to the first embodiment of the present invention may be applied to both a static communication module and a dynamic communication module. The static may mean a case in which the communication module is stopped, and the dynamic may mean a case in which the communication module moves.

Meanwhile, the contents described with reference to FIG. 1 may also be applied to second to fourth embodiments to be described below.

Referring to FIG. 2, the security device 100 according to the first embodiment of the present invention, which is communicatively connected to various electronic devices 10 on a communication network, may include a communication antenna 110, a random number generator 120, a memory 130, and a control unit 140.

The communication antenna 110 may receive communication signals from various electronic devices 10. For example, the communication antenna 110 may receive communication signals transmitted from various electronic devices 10 through wireless communication networks such as Wi-Fi, mobile communication, RF, Zigbee, LoRa, and Bluetooth. In this case, the communication antenna 110 may receive a wireless communication signal in units of DBM (decibels above 1 mW), mW, and mV.

In addition, the communication antenna 110 may transmit the random number, which is generated by the random number generator 120 based on the communication signal, and encrypted information, which is generated by the control unit 140 based on the random number, to the electronic device 10.

The random number generator 120 may generate a random number based on a communication signal received in the communication antenna 110. The random number generator 120 may generate a new random number whenever a communication signal is received in the communication antenna 110. That is, the random number generator 120 may generate a random number by using a disordered change in the intensity or sensitivity of a communication signal received in the communication antenna 110 in real time.

The random number generator 120 according to the first embodiment of the present invention may generate a random number based on a communication signal received from the electronic device 10, which is directly connected for communication, among the communication signals received in the communication antenna 110.

The communication antenna 110 according to the first embodiment of the present invention may receive communication signals generated from various electronic devices 10 that are communicatively connected through the communication network. That is, the communication antenna 110 may receive a communication signal between the electronic devices 10 in addition to a communication signal generated from the electronic device 10 directly connected to the communication antenna.

Accordingly, the random number generator 120 may generate a random number based on the communication signal even when a signal regarded as noise by the communication antenna 110 is received.

Since the random number generator 120 can utilize even a signal regarded as noise by the communication antenna 110 to generate a random number, the amount of generated random numbers and the generation rate of the random number may be improved.

As described above, the random number generator 120 according to the first embodiment of the present invention may generate a physical random number based on a communication signal, and alternatively, may generate a random number in an algorithmic manner. In addition, the random number generator 120 may generate a random number using a circuit method such as a ring oscillator.

In the following description, it is assumed that the random number generator 120 generates a physical random number based on a communication signal.

For example, when a DBM communication signal is received in the communication antenna 110, the random number generator 120 may convert the DBM communication signal into a unit of mW, and convert the converted mW value into a binary number to generate a random number.

In addition, when mW or mV communication signals are received in the communication antenna 110, the random number generator 120 may generate a random number by converting values of the communication signals into binary numbers.

The memory 130 may store information on the electronic device 10 integrally provided with the security device 100 according to the first embodiment of the present invention. For example, when the electronic device 10 integrally provided with the security device 100 is a medical wearable device, the memory 130 may store unique information of the medical wearable device and biometric information measured by the medical wearable device.

As another example, when the electronic device 10 integrally provided with the security device 100 is an Internet of Things device installed in a home, the memory 130 may store unique information of the Internet of Things device and information on the environment and status of the home and living patterns of residents, etc., collected by the Internet of Things device.

The control unit 140 according to the first embodiment of the present invention may encrypt information through a symmetric key algorithm, and may cause the encrypted information to be decrypted by the electronic device 10 or the external electronic device 101.

The external electronic device 101 may be, for example, a cloud-type server that manages and stores information measured or collected from various electronic devices 10.

Referring to FIG. 3, the control unit 140 according to the first embodiment may include an encryption key generator 141 and an encryption unit 142.

The encryption key generator 141 may generate an encryption key using the random number generated by the random number generator 120.

The encryption unit 142 may encrypt information stored in the memory (130 in FIG. 2) using the encryption key generated by the encryption key generator 141.

Hereinafter, the present invention will be described in a time series manner with reference to FIGS. 4 to 7.

Referring to FIG. 4, when receiving a request for information through a communication signal from the electronic device 10 (S11), the security device 100 may generate a new random number through the random number generator 120 based on the communication signal whenever the communication signal is received (S12), and the generated random number may be provided to the encryption key generator 141 (S13).

Then, the security device 100 may generate an encryption key through the encryption key generator 141 using a random number (S14), and provide the generated encryption key to the encryption unit 142 (S15).

Thereafter, the security device 100 may encrypt information with the encryption key through the encryption unit 142 (S16), and transmit the encrypted information and the encryption key to the electronic device 10 through the communication antenna 110 (S17, S18).

Accordingly, the electronic device 10 may decrypt the encrypted information using the encryption key transmitted from the security device 100 (S19).

Referring to FIG. 5, after that, the electronic device 10 may transmit the decrypted information to the external electronic device 101 provided as, for example, a cloud-type server (S19-1).

The external electronic device 101 that has received the decrypted information from the electronic device 10 may store the decrypted information (S19-2).

Meanwhile, referring to FIG. 6, the electronic device 10 may transmit the encrypted information transmitted from the security device 100 to the external electronic device 101 together with the encryption key without decrypting the encrypted information (S19-3).

Accordingly, the external electronic device 101 may decrypt the encrypted information using the encryption key transmitted from the electronic device 10 (S19-4).

Then, the external electronic device 101 may store the decrypted information (S19-5).

Meanwhile, referring to FIG. 7, the security device 100 according to the first embodiment of the present invention may generate a new random number based on a communication signal whenever a communication signal is received, and may periodically provide encrypted information to the electronic device 10 by encrypting the information based on the new random number.

That is, even when there is no separate request for information from the electronic device 10, if a communication signal is received in the communication antenna 110 (S21), the security device 100 according to the first embodiment of the present invention may generate a new random number through the random number generator 120 based on the communication signal whenever a communication signal is received (S22), and may provide the generated random number to the encryption key generator 141 (S23).

Next, the security device 100 may generate an encryption key through the encryption key generator 141 using a random number (S24), and provide the generated encryption key to the encryption unit 142 (S25).

Then, the security device 100 may encrypt the information with the encryption key through the encryption unit 142 (S26), and transmit the encrypted information and the encryption key to the electronic device 10 through the communication antenna 110 every set time period (S27, S28).

Accordingly, the electronic device 10 may decrypt the encrypted information using the encryption key transmitted from the security device 100 (S29).

For example, the security device 100 according to the first embodiment of the present invention may be provided integrally with a medical wearable device. Accordingly, if the security device 100 periodically provides biometric information measured through the medical wearable device to the electronic device 10, it is possible to simply and continuously monitor the health condition of a wearer of the medical wearable device. The electronic device 10 may be, for example, a smart phone possessed by the wearer's family or medical staffs.

Meanwhile, although not shown in the drawings, the electronic device 10 that decrypts the encrypted information periodically provided from the security device 100 at every set time using the encryption key may transmit the decrypted information to the external electronic device 101 and the external electronic device 101 may store the decrypted information.

In addition, the electronic device 10 may transmit the encrypted information periodically transmitted from the security device 100 to the external electronic device 101 together with the encryption key without decrypting the encrypted information, and thus, the external electronic device 101 may decrypt the encrypted information using the encryption key received from the electronic device 10 and store the decrypted information to manage the decrypted information.

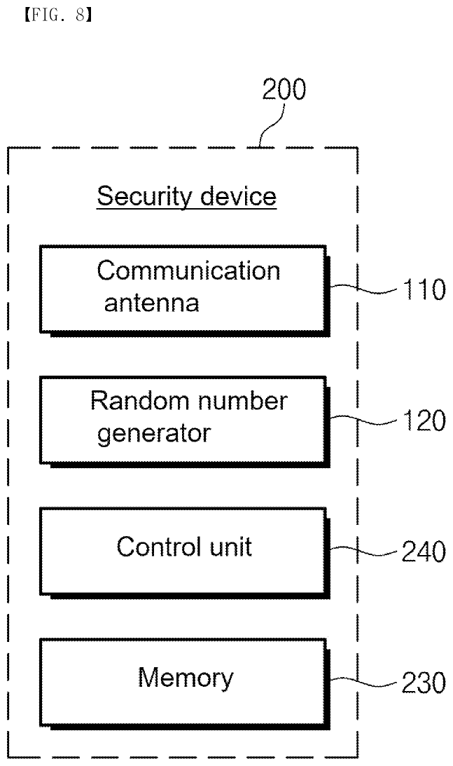

Hereinafter, a security device according to a second embodiment of the present invention will be described with reference to FIGS. 8 to 11.

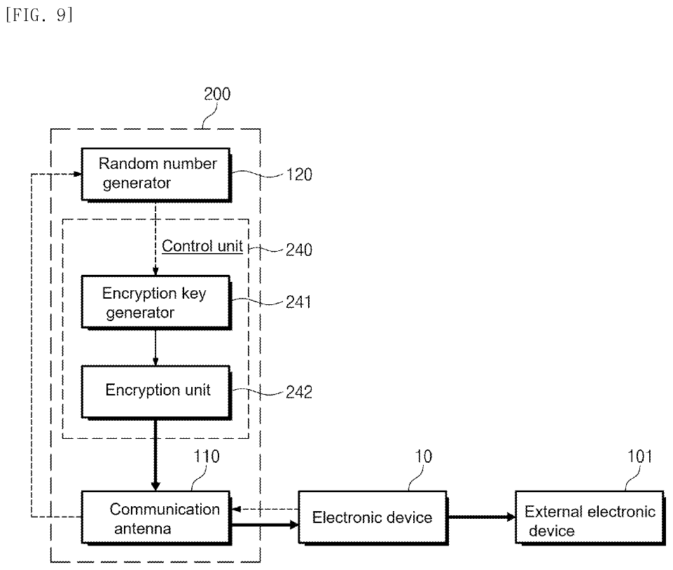

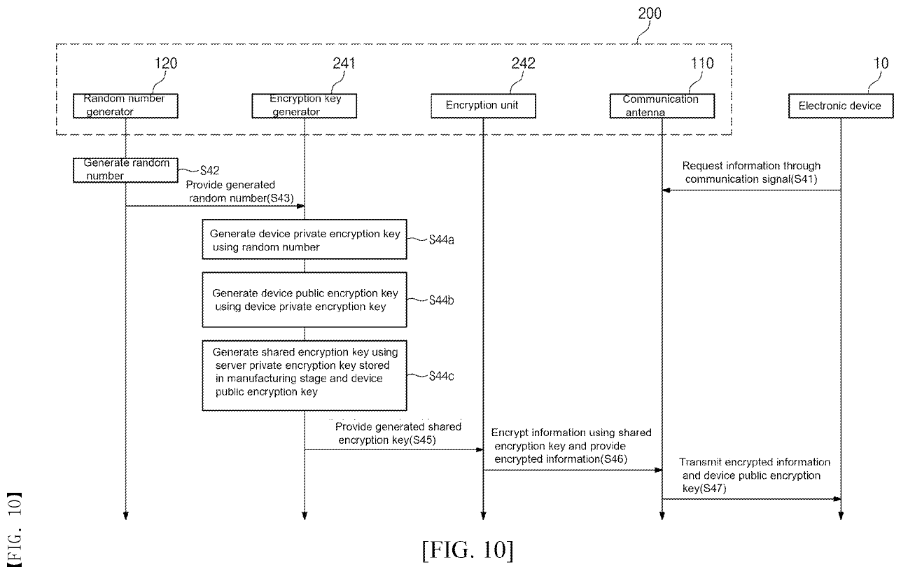

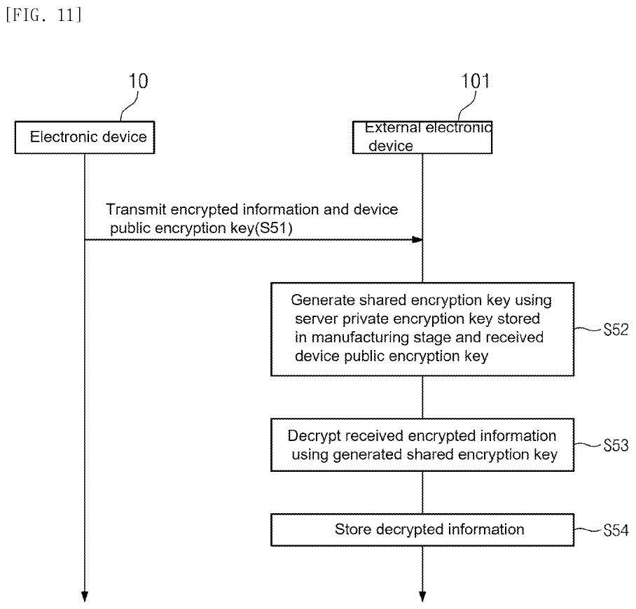

FIG. 8 is a block diagram illustrating a security device according to a second embodiment of the present invention, FIG. 9 is a block diagram illustrating a control unit of the security device according to the second embodiment of the present invention, FIG. 10 is a flowchart for explaining an information encryption process of a control unit when information is requested by an electronic device according to the second embodiment of the present invention, and FIG. 11 is a flowchart illustrating a communication process between an electronic device and an external electronic device according to the second embodiment of the present invention.

Referring to FIG. 8, the security device 200 according to the second embodiment of the present invention may include a communication antenna 110, a random number generator 120, a memory 230, and a control unit 240.

When compared with the first embodiment of the present invention, the second embodiment of the present invention differs only in the encryption algorithm of the memory and the control unit, so the same reference numerals are given to the same components, and detailed descriptions thereof will be omitted.

The memory 230 according to the second embodiment of the present invention may store information on the electronic device 10 provided integrally with the security device 200 according to the second embodiment of the present invention. For example, when the electronic device 10 integrally provided with the security device 200 is a medical wearable device, the memory 230 may store unique information of the medical wearable device and biometric information measured by the medical wearable device.

As another example, when the electronic device 10 integrally provided with the security device 200 is an Internet of Things device installed in a home, the memory 230 may store unique information of the Internet of Things device and information on the environment and status of the home and living patterns of residents, etc., collected by the Internet of Things device.

The memory 230 according to the second embodiment of the present invention may further store a server private encryption key (PaServer). In this case, the server private encryption key (PaServer) may be stored in the memory 230 in the manufacturing stage.

The server private encryption key (PaServer) is used to generate a shared encryption key (S Key) in the control unit 240, which will be described below in more detail.

Referring to FIG. 9, the control unit 240 according to the second embodiment of the present invention may encrypt information through an asymmetric key algorithm, and the encrypted information may be decrypted by the electronic device 10 or the external electronic device 101 provided in the form of a cloud server. In the following description, it is assumed that the external electronic device 101 is a server.

The control unit 240 according to the second embodiment of the present invention may include an encryption key generator 241 and an encryption unit 242.

The encryption key generator 241 may generate a device private encryption key (PaDevice) by using the random number generated by the random number generator 120.

In addition, the encryption key generator 241 may generate a device public encryption key (PuDevice) based on the device private encryption key (PaDevice). In this case, the encryption key generator 241 may generate a device public encryption key (PuDevice) based on the device private encryption key (PaDevice) using a mathematical method, for example, an elliptic curve constant G.

In addition, the encryption key generator 241 may generate a shared encryption key (S Key) based on the random number generated by the random number generator 120. For example, the encryption key generator 241 may generate a shared encryption key (S Key) using the device public encryption key (PuDevice) and the server private encryption key (PaServer).

As another example, the encryption key generator 241 may generate a shared encryption key (S Key) using the device private encryption key (PaDevice) and the server personal encryption key (PaServer).

Since the shared encryption key (S Key) is generated based on a random number, it is possible to provide improved security strength.

Hereinafter, for convenience of explanation, it is assumed that the encryption key generator 241 generates a shared encryption key (S Key) by utilizing the device public encryption key (PuDevice) and the server private encryption key (PaServer).

For reference, the server private encryption key (PaServer) may be previously stored in the memory (230 in FIG. 8). For example, the server private encryption key (PaServer) may be stored in advance when the security device 200 according to the second embodiment of the present invention is shipped from the factory.

In addition, according to the second embodiment of the present invention, the server private encryption key (PaServer) identical to the server public encryption key (PuServer) stored in the memory 230 may also be stored in the external electronic device 101 provided as a server.

Meanwhile, the encryption unit 242 may encrypt information stored in the memory (230 in FIG. 8) using the shared encryption key (S Key) generated by the encryption key generator 241.

As described above, the random number generator 120 may newly generate a random number whenever a communication signal is received. Thus, since the encryption key generator 241 can continuously regenerate the device private encryption key (PaDevice), the device shared encryption key (PuDevice) and the shared encryption key (S key), the shared encryption key (S Key) may be refreshed whenever a communication signal is received.

Hereinafter, the present invention will be described in a time series manner with reference to FIGS. 10 and 11.

As a pre-step of step S41, a step of provisioning a server private encryption key (PaServer) may be performed. As described above, this may mean that the same server private encryption key (PaServer) is stored in the memory 230 and the external electronic device 101 of the security device 200 according to the second embodiment of the present invention, and this may be performed during an initial setting stage, for example, at the time of shipment from the factory.

Referring to FIG. 10, when receiving a request for information through a communication signal from the electronic device 10 (S41), the security device 200 may newly generate a random number through the random number generator 120 based on a communication signal whenever the communication signal is received (S42), and the generated random number may be provided to the encryption key generator 241 (S43).

Next, the security device 200 may generate a device private encryption key (PaDevice) through the encryption key generator 241 by using the random number (S44a).

In addition, the security device 200 may generate a device shared encryption key (PuDevice) through the encryption key generator 241 by utilizing the device private encryption key (PaDevice) (S44b).

Then, the security device 200 may generate a shared encryption key (S Key) through the encryption key generator 241 using the server private encryption key (PaServer) stored in the manufacturing stage of the security device 200, and the generated device public encryption key (PuDevice) (S44c).

As described above, since a random number is used as a seed signal of the shared encryption key (S Key), a new random number is generated whenever communication information is received, and accordingly, the shared encryption key (S Key) may be newly refreshed.

Next, the security device 200 may provide the shared encryption key (S Key) generated through the encryption key generator 241 to the encryption unit 242 (S45).

Then, the security device 200 may encrypt information through the encryption unit 242 using the shared encryption key (S Key) and provide the encrypted information to the communication antenna 110 (S46).

Next, the security device 200 may transmit the encrypted information and the device public encryption key (PuDevice) to the electronic device 10 through the communication antenna 110 (S47).

Subsequently, referring to FIG. 11, the electronic device 10 may provide the encrypted information and the device public encryption key (PuDevice), which are received in step S47, to the external electronic device 101 (S51).

The external electronic device 101 may generate a shared encryption key (S Key) using the server private encryption key (PaServer) pre-stored in the manufacturing stage of the security device 200 and the received device public encryption key (PuDevice) (S52).

Next, the external electronic device 101 may decrypt the received encrypted information using the generated shared encryption key (S Key) (S53).

Then, the external electronic device 101 may store the decrypted information (S54).

Since it is assumed that the external electronic device 101 is a cloud server in the second embodiment described above, it has been described in that the encryption key generator 241 generates the shared encryption key (S Key) by utilizing the server private encryption key (PaServer). As a modified example, a master key may be used instead of a server private encryption key (PaServer). If the server private encryption key (PaServer) is a specialized encryption key that can be used with one security device, the master key may mean an encryption key that can be used by a plurality of security devices.

In the present embodiment, a public encryption key (PuDevice) to be refreshed is also used in addition to the server private encryption key (PaServer) to generate the shared encryption key (S Key). That is, even if the master key is provided, it is still necessary to use the device public encryption key (PuDevice) to be refreshed in order generate the shared encryption key. Thus, even if a plurality of security devices use the same master key to generate the shared encryption key, the shared encryption key generated by each security device may be individually different. This is because the device public encryption key is different in each security device, and in particular, the device public encryption key changes every moment even in the same security device due to the refresh.

Accordingly, when a master key is provided rather than a server private encryption key (PaServer) specialized for one security device, it can still provide excellent security, and furthermore, since the same master key that is provisioned at the time of production of the security device is used for each security device, the master key may be easily created and managed.

Meanwhile, as another modified example, the external electronic device 101 may decrypt and store the received encrypted information using a master key previously provided for the external electronic device 101.

As another modified example, a step of provisioning a server public encryption key (PuServer) may be performed. As described above, this may mean that the same server public encryption key (PuServer) is stored in the memory 230 and the external electronic device 101 of the security device 200 according to the second embodiment of the present invention, and this may be performed in an initial setting step, for example, at the time of shipment from the factory.

When receiving a request for information from the electronic device 10 through a communication signal, the security device 200 may newly generate a random number through the random number generator 120 based on a communication signal whenever the communication signal is received, and provide the generated random number to the encryption key generator 241.

Next, the security device 200 may generate a device private encryption key (PaDevice) through the encryption key generator 241 by using the random number.

In addition, the security device 200 may generate a device shared encryption key (PuDevice) through the encryption key generator 241 by using the device private encryption key (PaDevice).

Then, the security device 200 may generate a shared encryption key (S Key) through the encryption key generator 241 by using the server public encryption key (PuServer) stored in the manufacturing stage of the security device 200, and the generated device public encryption key (PuDevice).

As described above, since a random number is used as a seed signal of the shared encryption key (S Key), a new random number is generated whenever communication information is received, and accordingly, the shared encryption key (S Key) may be newly refreshed.

Next, the security device 200 may provide the shared encryption key (S Key) generated through the encryption key generator 241 to the encryption unit 242.

Then, the security device 200 may encrypt the information through the encryption unit 242 using the shared encryption key (S Key) and provide the encrypted information to the communication antenna 110.

After that, the security device 200 may transmit the encrypted information and the device public encryption key (PuDevice) to the electronic device 10 through the communication antenna 110.

Accordingly, the electronic device 10 may provide the encrypted information and the device public encryption key (PuDevice) received from the security device 200 to the external electronic device 101.

The external electronic device 101 may generate a shared encryption key (S Key) using the server public encryption key (PuServer) stored in advance in the manufacturing stage of the security device 200 and the received device public encryption key (PuDevice).

Then, the external electronic device 101 may decrypt the received encrypted information using the generated shared encryption key (S Key).

Then, the external electronic device 101 may store the decrypted information.

The random number may be the same as the encryption key. In the present invention, the encryption may be understood as a concept including encryption with a random number as well as encryption with an encryption key. In another aspect, the random number generator and the encryption key generator may have the same configuration.

In the above description of the first and second embodiments, the security devices 100 and 200 are illustrated to have a configuration separated from the electronic device 10 in terms of hardware, but the security devices 100 and 200 may form a part of a configuration of the electronic device 10. That is, the electronic device 10 may perform the functions of the security devices 100 and 200 according to the first and/or second embodiment.

In addition in the first and second embodiments, the communication antennas of the security devices 100 and 200 may be short-range communication antennas (center frequency 13.56 MHz). In this case, the security devices 100 and 200 according to the first and second embodiments may be driven in a powerless manner.

This will be described below in detail.

When receiving a request for delivery of specific data from the external electronic device 101 in a state in which specific data is stored in the memories of the first and second security devices 100 and 200, the tagging may be performed between the security devices 100 and 200 and the external electronic device 101.

In this case, radio frequency (RF) energy may be generated in the communication antennas of the security devices 100 and 200 according to the first and second embodiments due to the tagging. The security devices 100 and 200 may generate a necessary encryption key, for example, a random number, a private encryption key, a public encryption key, and a shared encryption key, based on the energy generated by the tagging of the external electronic device 101, and may encrypt data to transmit the encrypted data to the external electronic device 101.

That is, the security devices 100 and 200 according to the first and second embodiments may perform secure communication without a separate battery.

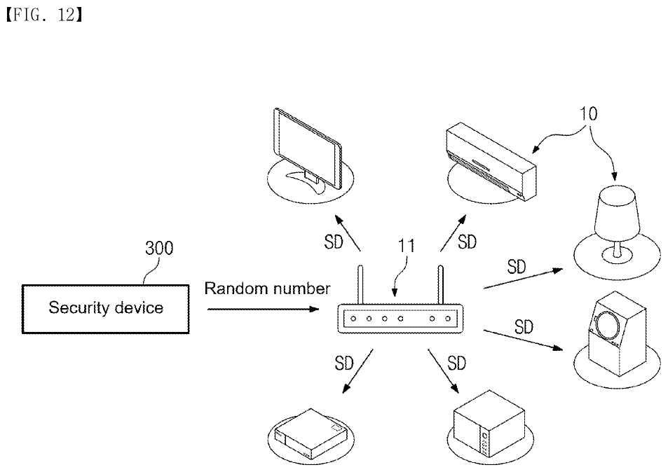

Hereinafter, a security device according to a third embodiment of the present invention will be described with reference to FIGS. 12 to 15.

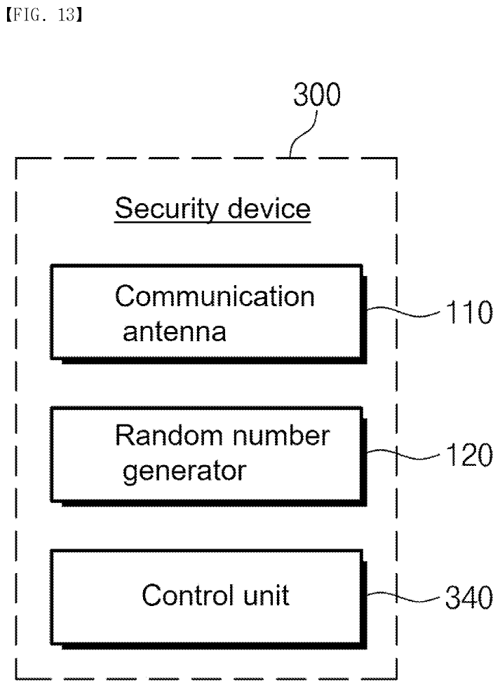

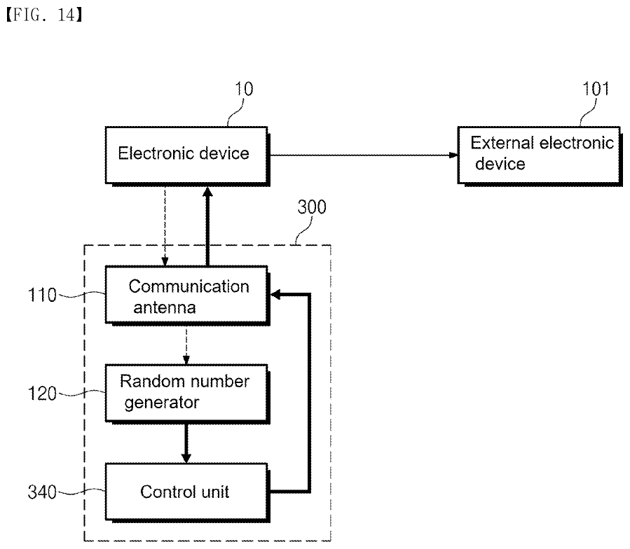

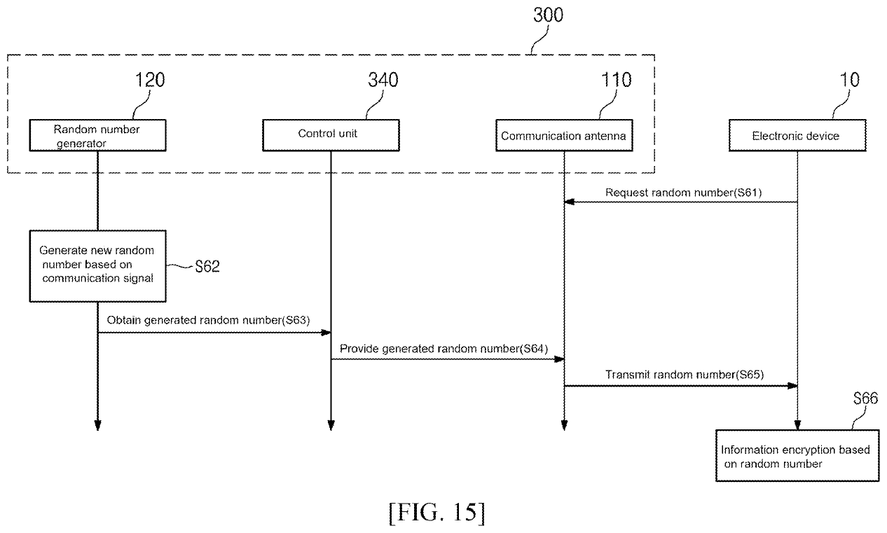

FIG. 12 is a schematic view for explaining a security device that is connected with various electronic devices for communication according to a third embodiment of the present invention, FIG. 13 is a block diagram illustrating a security device according to the third embodiment of the present invention, FIG. 14 is a reference view for explaining information flow between a security device, an electronic device, and an external electronic device according to the third embodiment of the present invention, and FIG. 15 is a flowchart illustrating a process of generating a random number and transmitting the random number to an electronic device in a time series manner when the random number is requested by the electronic device according to the third embodiment of the present invention.

As shown in FIG. 12, the security device 300 according to the third embodiment of the present invention may generate a random number that no one can predict based on a communication signal received from the electronic device 11 requesting random number information among various electronic devices 10 that are communicatively connected on a communication network, and may transmit the generated random number to the electronic device 11 requesting the random number information.

Accordingly, the electronic device 11 requesting the random number information may encrypt information based on the random number received from the security device 300 and provide the encrypted information SD to the various electronic devices 10 requesting the information.

Thus, it is possible to escape from the risk of hacking and to establish a communication network having an excellent security system.

In the third embodiment of the present invention, the communication signal used to generate the random number may be a wireless communication signal transmitted through any one or at least two of communication networks including Wi-Fi, mobile communication, RF, Zigbee, LoRa, and Bluetooth. In addition in the third embodiment of the present invention, the communication signal used to generate the random number may be a wired communication signal transmitted through a wired communication network.

In the third embodiment of the present invention, the electronic device 11 that is communicatively connected to the security device 300 and requests a random number may be a wireless communication module such as a Wi-Fi module, a mobile communication module, an RF module, a Zigbee module, a LoRa module, and a Bluetooth module.

In addition, in the third embodiment of the present invention, the various electronic devices 10 communicatively connected to the security device 300 and the electronic device 11 that requests a random number may include Internet of Things (IoT) devices, augmented reality devices and medical wearable devices.

In the third embodiment of the present invention, the electronic device 11 requesting a random number to the security device 300 is distinguished from other various electronic devices 10 receiving encrypted information from the electronic device 11 for the purpose of convenience of explanation, but the electronic device 11 requesting a random number to the security device 300 may mean any one of the various electronic devices 10.

The security device 300 according to the third embodiment of the present invention may be integrally provided with any one of the various electronic devices 10. That is, the security device 300 according to the third embodiment of the present invention may form a single chip with any one electronic device 10. However, it is also possible to provide the security device 300 according to the third embodiment of the present invention independently from the electronic device 10.

Similar to the first embodiment, the security device 300 according to the third embodiment may be applied to both a static communication module and a dynamic communication module.

Referring to FIG. 13, the security device 300 according to the third embodiment of the present invention may include a communication antenna 110, a random number generator 120, and a control unit 340.

When compared with the first embodiment of the present invention, the third embodiment of the present invention differs in that the memory is omitted and the operation of the control unit is changed, so the same reference numerals are given to the same components, and detailed descriptions thereof will be omitted.

Referring to FIG. 14, the control unit 340 according to the third embodiment of the present invention may transmit the random number to the electronic device 10 through the communication antenna 110 such that information stored in the electronic device 10 communicatively connected to the control unit can be encrypted based on the random number generated through the random number generator 120. In this case, the electronic device 10 may be an electronic device (11 in FIG. 12) that has requested random number information to the security device 300. The electronic device 10 may be provided with an encryption device for encrypting information based on the random number.

Accordingly, when information is requested from various electronic devices 10 including the external electronic device 101, the electronic device 10 receiving the random number from the security device 300 encrypts the information based on the random number and transmits the encrypted information SD to the various electronic devices 10.

Hereinafter, the present invention will be described in a time series manner with reference to FIG. 15.

Referring to FIG. 15, when receiving a request for a random number from the electronic device 10 through a communication signal (S61), the security device 300 may generate a new random number through the random number generator 120 based on the communication signal whenever the communication signal is received (S62).

Next, the security device 300 may obtain the random number generated from the random number generator 120 through the control unit 340 (S63) and provide the random number to the communication antenna 110 (S64).

Then, the security device 300 may transmit the random number to the electronic device 10 through the communication antenna 110 (S65).

Accordingly, the electronic device 10 may encrypt information based on the random number received from the security device 300. In this case, when the electronic device 10 receives a request for information from other electronic devices 10 or an external electronic device 101 provided in the form of a cloud server, the electronic device 10 encrypts the information based on the random number and transmits the encrypted information to the other electronic devices or the external electronic device 101.

As described above, the security devices 100, 200, and 300 according to the embodiments of the present invention may newly generate the random number whenever the communication signal is received based on the communication signal received from the electronic device 10 that is communicatively connected in the communication network environments such as Wi-Fi, mobile communication, RF, Zigbee, LoRa, and Bluetooth.

In this case, the security devices 100, 200, and 300 according to the embodiments of the present invention may encrypt information using the random number generated based on the communication signal, and provide the encrypted information to the electronic device 10 or may provide the random number to the electronic device 10 so that information may be encrypted based on the random number.

Therefore, according to the embodiments of the present invention, it is possible to improve the security of the electronic device 10, and accordingly, it is possible to establish a security system, which is safe against hacking or can keep the hacking risk at the lowest level, in the communication network environment.

For example, when the security devices 100, 200, and 300 according to the embodiments of the present invention are provided integrally with a gateway installed in a home, office, or building, the security strength of various IoT devices installed in a home, office or building may be improved.

In addition, when the security devices 100, 200, and 300 according to the embodiments of the present invention are provided integrally with a medical wearable device that collects and measures biometric information or provided on the same communication network as the medical wearable device, the hacking risk for personal information can be kept at the lowest level.

The functions of the security device according to the first to third embodiments described above with reference to FIGS. 1 to 15 may be provided as a security program stored in a computer-readable recording medium. That is, the security program for transmitting the encrypted data and the security program for receiving and decrypting the encrypted data according to the first to third embodiments may be provided. The program code implemented by the security program has been described in detail with reference to FIGS. 1 to 15, in particular, in the flowcharts of each embodiment, so detailed description thereof will be omitted.

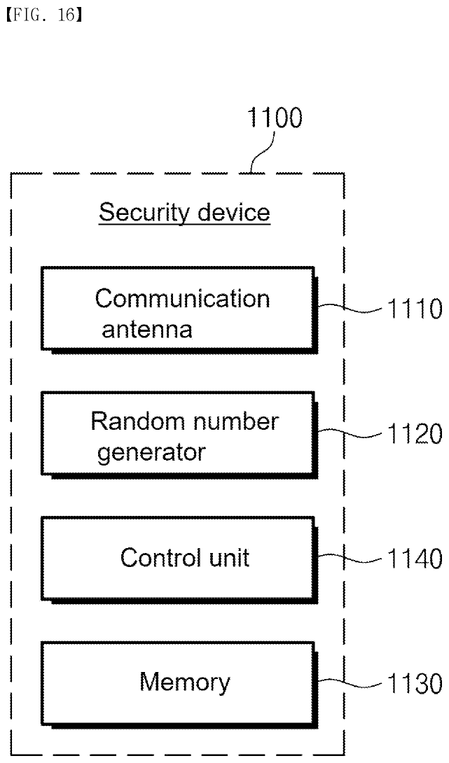

Hereinafter, a security device according to a fourth embodiment of the present invention will be described with reference to FIGS. 16 to 21.

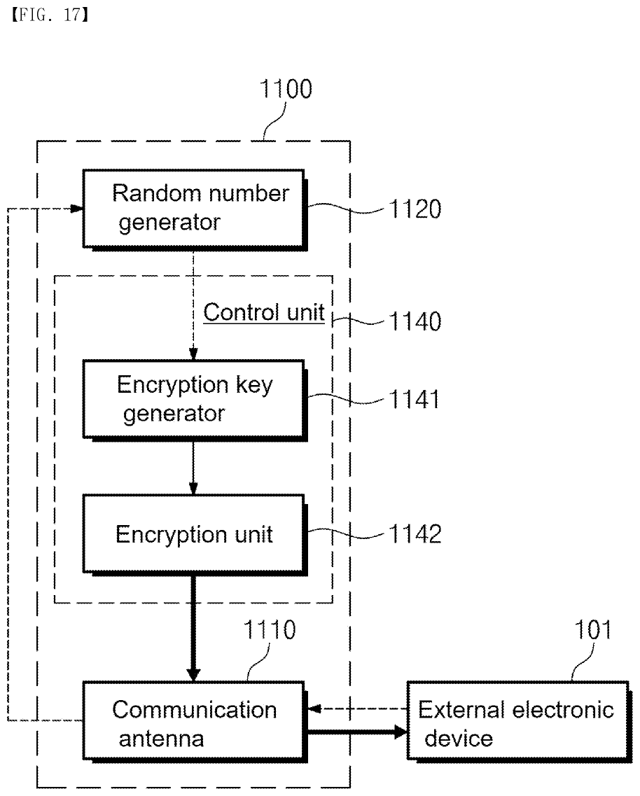

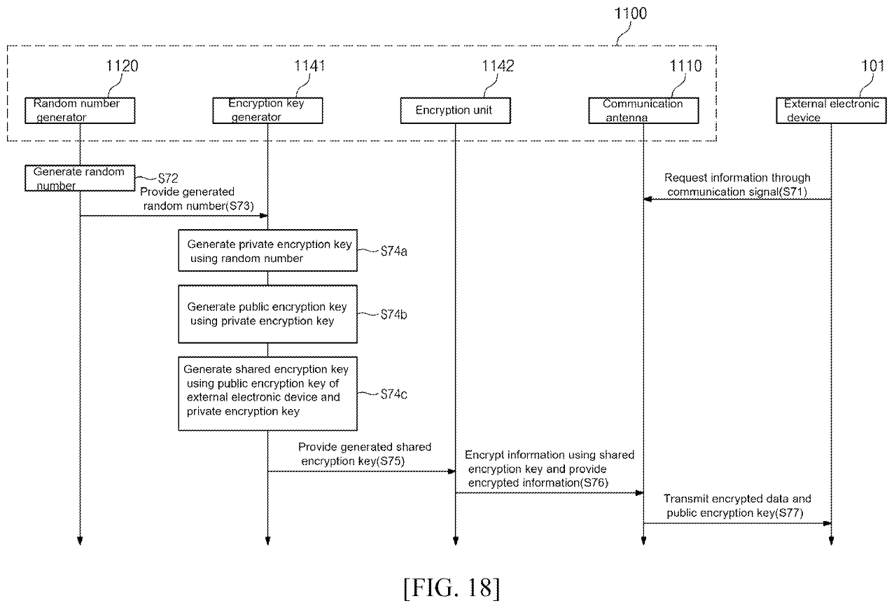

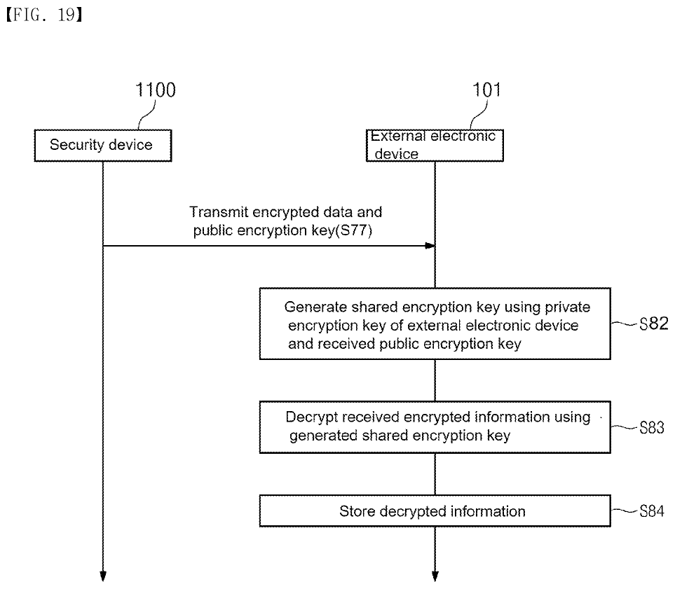

FIG. 16 is a block diagram illustrating a security device according to a fourth embodiment of the present invention, FIG. 17 is a block diagram illustrating a control unit of the security device according to the fourth embodiment of the present invention, FIG. 18 is a flowchart for explaining an information encryption process of a control unit in a time series manner when information is requested by an electronic device according to the fourth embodiment of the present invention, and FIG. 19 is a flowchart for explaining a communication process between an electronic device and an external electronic device in a time series manner according to the fourth embodiment of the present invention when encrypted information is decrypted on the electronic device side.

Referring to FIG. 16, the security device 1100 according to one embodiment of the present invention, which is communicatively connected to various electronic devices 10 on a communication network or accommodated in various electronic devices 10, may include a communication antenna 1110, a random number generator 1120, a memory 1130, and a control unit 1140.

The communication antenna 1110 may receive communication signals from various electronic devices 10. For example, the communication antenna 1110 may receive communication signals transmitted from various electronic devices 10 through a wireless communication network such as Wi-Fi, mobile communication, RF, Zigbee, LoRa, Near-Field communication, and Bluetooth. In this case, the communication antenna 1110 may receive a wireless communication signal in a unit of DBM (decibels above 1 mW), mW, and mV.

In addition, the communication antenna 1110 may transmit the random number generated by the random number generator 1120 based on the communication signal and the encrypted information generated based on the random number by the control unit 1140 to the electronic device 10.

The random number generator 1120 may generate the random number based on the communication signal received in the communication antenna 1110. The random number generator 1120 may generate a new random number whenever a communication signal is received in the communication antenna 1110. That is, the random number generator 1120 may generate the random number by using disordered change in the intensity or sensitivity of a communication signal received the communication antenna 1110 in real time.

The random number generator 1120 according to one embodiment of the present invention may generate a random number based on a communication signal received from the electronic device 10, which is directly connected for communication, among the communication signals received in the communication antenna 1110.

The communication antenna 1110 according to one embodiment of the present invention may receive communication signals generated from various electronic devices 10 communicatively connected through a communication network. That is, the communication antenna 1110 may receive a communication signal between the electronic devices 10 in addition to the communication signal generated from the electronic device 10 directly connected to the communication antenna.

Accordingly, the random number generator 1120 may generate a random number based on the communication signal even when a signal regarded as noise by the communication antenna 1110 is received.

Since the random number generator 1120 can utilize even a signal regarded as noise by the communication antenna 1110 to generate a random number, the amount of generated random numbers and the generation rate of the random number may be improved.

As described above, the random number generator 1120 according to one embodiment of the present invention may generate a physical random number based on a communication signal, and alternatively, may generate a random number in an algorithmic manner. In addition, the random number generator 1120 may generate a random number using a circuit method such as a ring oscillator.

In the following description, it is assumed that the random number generator 1120 generates a physical random number based on a communication signal.

For example, when a DBM communication signal is received in the communication antenna 1110, the random number generator 1120 may convert the DBM communication signal into a unit of mW, and convert the converted mW value into a binary number to generate a random number.

In addition, when mW or mV communication signals are received in the communication antenna 1110, the random number generator 1120 may generate a random number by converting values of the communication signals into binary numbers.

The memory 1130 may store information on the electronic device 10 integrally provided with the security device 1100 according to one embodiment of the present invention. For example, when the electronic device 10 integrally provided with the security device 1100 is a medical wearable device, the memory 1130 may store unique information of the medical wearable device and biometric information measured by the medical wearable device.

As another example, when the electronic device 10 integrally provided with the security device 1100 is an Internet of Things device installed in a home, the memory 1130 may store unique information of the Internet of Things device and information on the environment and status of the home and living patterns of residents, etc., collected by the Internet of Things device.

Referring to FIG. 17, the control unit 1140 according to one embodiment may further include at least one of an encryption key generator 1141 and an encryption unit 1142.

The encryption key generator 1141 of the control unit 1140 may generate a key based on the random number generated by the random number generator 1120. For example, the encryption key generator 1141 may generate a public encryption key (Pub_Sender) from the private encryption key (Priv_Sender) and the private encryption key (Priv_Sender) of the encrypted data transmitting side.

In this case, the private encryption key (Priv_Sender) and the public encryption key (Pub_Sender) may have a one-way relationship. The one-way relationship means that a public encryption key (Pub_Sender) may be generated based on the private encryption key (Priv_Sender), but a private encryption key (Priv_Sender) may not be generated based on the public encryption key (Pub_Sender). In terms of security safety, the private encryption key (Priv_Sender) is used in actual encryption, only the public encryption key (Pub_Sender) is transmitted to the receiving side of the encrypted data, and the private encryption key (Priv_Sender) is not transmitted, thereby reinforcing the security. Even if the public encryption key (Pub_Sender) transmitted to the receiving side of the encrypted data is revealed, since the public encryption key (Pub_Sender) cannot be used as the private encryption key (Priv_Sender) used for encryption, data encryption is still safe.

The encryption key generator 1141 may generate a shared encryption key (S Key). The shared encryption key (S Key) may mean a key used for data encryption.

The encryption key generator 1141 may generate a shared encryption key (S Key) in various ways. For example, the encryption key generator 1141 may generate a shared encryption key (S Key) based on at least two source keys (source key).

More specifically, the source key of the encryption key generator 1141 may include a private encryption key (Priv_Sender) for transmission and a public encryption key (Pub_Server) of the external electronic device 101 for reception. The public encryption key (Pub_Server) of the external electronic device 101 for reception may be previously stored in the memory 1130. Alternatively, it may be received from the external electronic device 101.

The encryption key generator 1141 may provide the generated shared encryption key (S Key) to the encryption unit 1142. The encryption unit 1142 may encrypt data to be transmitted based on the shared encryption key (S Key). The encrypted data may be transmitted to the external electronic device 101 through the communication antenna 1110. In this case, the public encryption key (Pub_Sender) of the security device 1000 may be transmitted to the external electronic device 101 as well.

The external electronic device 101 may decrypt the received encrypted data. In this case, the external electronic device 101 may generate a shared encryption key (S Key) the same as that of the security device 1000 through another source key.

More specifically, the external electronic device 101 may generate the shared encryption key (S Key) the same as that of the security device 1000 through the private encryption key (Priv_Receiver) thereof and the received public encryption key (Pub_Sender). For example, the shared encryption key (S Key) the same as that of the security device 1000 may be generated through a predetermined equation based on the private encryption key (Priv_Receiver) of the external electronic device and the received public encryption key (Pub_Sender).

That is, the following relationship is established.

Shared encryption key (S Key)=f{Sender's private encryption key (Priv_Sender)*Receiver's public encryption key (Pub_Receiver)}=f(Sender's public encryption key (Pub_Sender)*Receiver's private encryption key (Priv_Sender))

Therefore, the shared encryption key used for encryption and the shared encryption key used for decryption are generated from different source keys. Accordingly, even if the shared encryption key is not shared through the communication channel, encryption and decryption are possible, so that very high security stability can be provided.

The communication antenna 1110 of the security device 1100 according to one embodiment may be a short-range communication antenna (center frequency 13.56 MHz). In this case, the security device 1100 according to one embodiment may be driven in a powerless manner.

This will be described below in detail as follows.

When receiving a request for delivery of specific data from the external electronic device 101 in a state in which specific data is stored in the memory 1130 of the security device 1100, the tagging may be performed between the security device 1100 according to one embodiment and the external electronic device 101.

In this case, radio frequency (RF) energy may be generated in the communication antenna 1110 of the security device 1100 due to the tagging. The security device 1100 may generate a random number, a private encryption key (Priv_Sender), a public encryption key (Pub_Sender), and a shared encryption key (S Key) based on the energy generated by the tagging of the external electronic device 101, and may encrypt data to transmit the encrypted data to the external electronic device 101 together with the public encryption key (Pub_Sender).

That is, the security device 1100 according to one embodiment may perform secure communication without a separate battery.

Hereinafter, the present invention will be described in a time series manner with reference to FIGS. 18 and 19.

For the purpose of convenience of explanation, it is assumed that the communication is performed by an NFC module.

Referring to FIG. 18, when a data request is received from the external electronic device 101 through a communication signal, that is, when the tagging is performed (S71), the security device 1100 according to one embodiment may generate energy based on the tagging signal through the random number generator 1120. By utilizing the generated energy, a new random number may be generated whenever a communication signal is received (S72), and the generated random number may be provided to the encryption key generator 1141 (S73).

Next, the security device 200 may generate a private encryption key (Priv_Sender) through the encryption key generator 1141 by using the random number (S74a).

In addition, the security device 200 may generate a public encryption key (Pub_Sender) by utilizing the private encryption key (Priv_Sender) through the encryption key generator 1141 (S74b).

Next, the security device 200 may generate the encryption key (S Key) through the encryption key generator 1141 by using the public encryption key (Pub_Receiver) of the external electronic device 101 and the public encryption key (Pub_Sender) generated in step S74b (S74c).

The public encryption key (Pub_Receiver) of the external electronic device 101 may be transmitted from the external electronic device 101 to the security device 1100 in step S71, or as another example, the public encryption key (Pub_Receiver) of the external electronic device 101 may be pre-stored in the memory of the security device 1100.

Meanwhile, as described above, since a random number is used as a seed signal of the shared encryption key (S Key), a new random number is generated whenever communication information is received, and accordingly, the shared encryption key (S Key) can be newly refreshed.

Next, the security device 1100 may provide the shared encryption key (S Key) generated through the encryption key generator 1141 to the encryption unit 1142 (S45).

Then, the security device 1100 may provide information to the communication antenna 1110 after encrypting the information through the encryption unit 1142 using the shared encryption key (S Key) (S1110).

Next, the security device 1100 may transmit the encrypted information and the public encryption key (Pub_Sender) generated in step S74b to the electronic device 10 through the communication antenna 1110 (S47).

Subsequently, referring to FIG. 19, the external electronic device 101 may generate a shared encryption key (S Key) using the private encryption key (Priv_Receiver) thereof and the received public encryption key (Pub_Sender) (S82).

Next, the external electronic device 101 may decrypt the received encrypted information using the generated shared encryption key (S Key) (S83).

Then, the external electronic device 101 may store the decrypted information (S84).

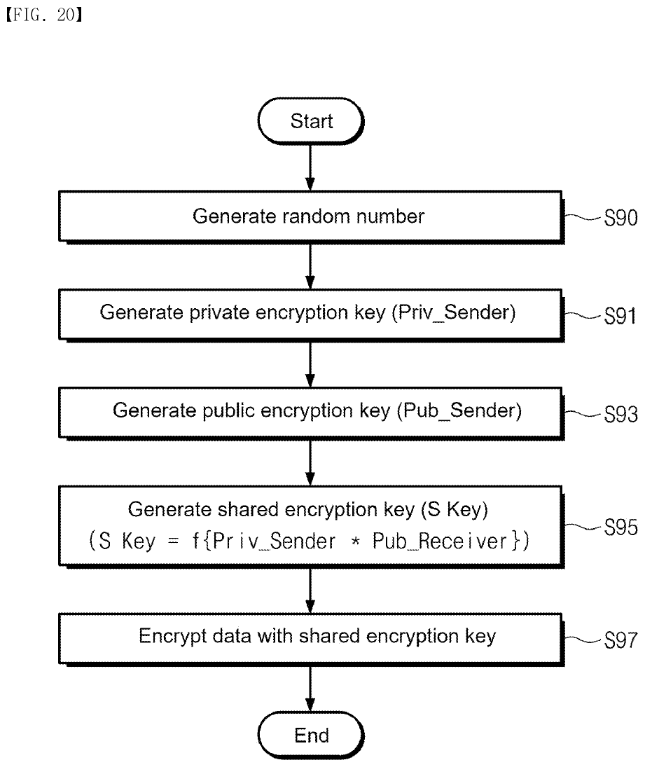

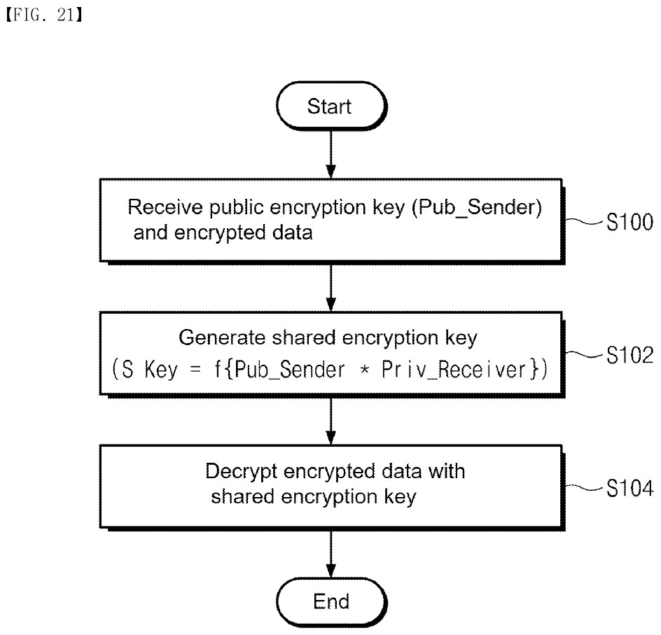

The security of the security device according to the fourth embodiment of the present invention has been described above with reference to FIGS. 18 and 19. Hereinafter, a security program of a security device according to a fourth embodiment of the present invention will be described with reference to FIGS. 20 and 21.

FIG. 20 is a view for explaining a security program of a transmission side of encrypted data according to a fourth embodiment of the present invention.

An electronic device equipped with the security program described with reference to FIG. 20 may operate as the above-described security device 1100.

The security program according to one example may be stored in a medium to execute steps S72, S73, S74a, S74b, S74c, S75, S76, and S77 described with reference to FIG. 18.

In particular, as shown in FIG. 20, the security program according to an example may be stored in a medium to execute the steps of generating a random number (S90), generating a private encryption key (Priv_Sender) (S91), generating a public encryption key (Pub_Sender) (S93), generating a shared encryption key (S Key) (S95) (S Key=f{Priv_Sender*Pub_Receiver}), and encrypting data using the public encryption key.

FIG. 21 is a view for explaining a security program of a side that receives encrypted data according to a fourth embodiment of the present invention.

The electronic device in which the security program described with reference to FIG. 21 is installed may operate as the external electronic device 101 described above.

The security program according to an example may be stored in a medium to execute at least one of steps S82, S83, and 84 described with reference to FIG. 19.

In particular, as shown in FIG. 21, the security program according to an example, may be stored in the medium in order to execute the steps of receiving a public encryption key (Pub_Sender) and encrypted data (S100), generating a shared encryption key (S102) (S Key=f{Pub_Sender*Priv_Receiver}), decrypting the encrypted data with the shared encryption key (S104).

Although the exemplary embodiments of the present invention have been described in detail, the scope of the present invention is not limited to a specific embodiment, and should be interpreted by the appended claims. In addition, it should be understood by those of ordinary skill in the art that various changes and modifications can be made without departing from the scope of the present invention.

1. A security device comprising:
a communication antenna for receiving a communication signal; and
a random number generator for newly generating a random number based on the communication signal received in the communication antenna.

2. The security device of claim 1, further comprising a control unit, wherein the control unit transmits the random number to an electronic device through the communication antenna so that information stored in the electronic device, which is connected to the control unit for communication, is encrypted based on the random number.

3. The security device of claim 1, further comprising a memory and a control unit, wherein the control unit includes:
an encryption key generator for generating an encryption key using the random number generated by the random number generator; and
an encryption unit for encrypting information stored in the memory using the generated encryption key, and
wherein, when the information is requested from the electronic device connected to the control unit for communication,
the control unit generates the encryption key by using the random number provided from the random number generator through the encryption key generator,
encrypts the information through the encryption unit, and
transmits the encrypted information and the generated encryption key to the electronic device through the communication antenna.

4. The security device of claim 1, further comprising a memory and a control unit, wherein the memory further stores a server encryption key, and
the control unit includes:
an encryption key generator configured to generate a device private encryption key (PaDevice) using the random number generated from the random number generator, generate a device public encryption key (PuDevice) based on the device private encryption key (PaDevice), and generate a shared encryption key (S Key) by using one of the device private encryption key (PaDevice) and the device public encryption key (PuDevice), and the server encryption key; and
an encryption unit configured to encrypt information stored in the memory using the generated shared encryption key (S Key), and
wherein, when the information is requested from the electronic device connected to the control unit for communication,
the control unit generates the device private encryption key (PaDevice), the device public encryption key (PuDevice), and the shared encryption key (S Key) using the random number provided from the random number generator through the encryption key generator,
encrypts the information with the shared encryption key (S Key) through the encryption unit, and
transmits the encrypted information and the generated device public encryption key (PuDevice) to the electronic device through the communication antenna, and
wherein the server encryption key is any one of a server private encryption key (PaSever) and a server public encryption key (PuServer).

5. The security device of claim 4, wherein any one of the electronic device and the external electronic device that manages the information provided from the electronic device utilizes the server encryption key stored in the memory and the device public encryption key (PuDevice) to decrypt the encrypted information.

6. The security device of claim 5, wherein the encryption key generator is configured to refresh the device private encryption key (PaDevice) using the newly generated random number so that the shared encryption key (S Key) is continuously regenerated.

7. The security device of claim 4, wherein the server encryption key is pre-stored before decryption in any one of the electronic device and an external electronic device that manages information provided from the electronic device.

8. The security device of claim 1, wherein the communication signal includes a communication signal transmitted through any one or at least two of communication networks including Wi-Fi, mobile communication, RF, Zigbee, LoRa, and Bluetooth.

9. The security device of claim 1, wherein the security device is integrally provided with any one communication module selected from communication modules including a Wi-Fi module, a mobile communication module, an RF module, a Zigbee module, a LoRa module, and a Bluetooth module.

10. A security program stored in a medium for performing the steps of:
generating a random number based on a radio frequency (RF) signal from an external electronic device;
encrypting data using the generated random number; and
transmitting the encrypted data to an external electronic device.

11. A security device comprising:
a communication antenna for receiving a communication signal;
an encryption unit for encrypting data with an encryption key; and
a control unit for transmitting encrypted data to an external electronic device through the communication antenna,
wherein the encryption key of the encryption unit and the encryption key used by the external electronic device to decrypt the encrypted data are derived from different source keys, and
the source key of the encryption key of the encryption unit is not transmitted to the external electronic device.

12. The security device of claim 11, wherein the encryption unit further includes a random number generator for generating a random number used to generate the encryption key based on the communication signal received in the communication antenna, and
wherein the random number and the encryption key are refreshed according to time as the received communication signal varies.

13. The security device of claim 12, wherein the encryption unit further includes an encryption key generator for generating a sensor private encryption key (Priv_sender) based on the random number generated by the random number generator, and generating a public encryption key (Pub_sender) from the private encryption key (Priv_sender), and
wherein the private encryption key (Priv_sender) and the public encryption key (Pub_sender) have a planar relationship where the public encryption key (Pub_sender) is generated based on the private encryption key (Priv_sender), and the private encryption key (Priv_sender) is not generated based on the public encryption key (Pub_sender).

14. The security device of claim 13, further comprising a memory for storing a public encryption key (Pub_receiver) of the external electronic device,
wherein a source key used by the encryption key generator to generate the encryption key includes the public encryption key (Pub_receiver) of the external electronic device stored in the memory and the private encryption key (Priv_sender) generated by the encryption key generator.

15. The security device of claim 14, wherein the control unit further transmits the public encryption key (Pub_sender) to the external electronic device through the communication antenna,
the external electronic device stores a private encryption key (Priv_receiver) used to generate the public encryption key (Pub_receiver) of the external electronic device, and
a source key of the encryption key used by the external electronic device to decrypt the received encrypted data includes the private encryption key (Priv_receiver) of the external electronic device and the received public encryption key (Pub_sender).

16. The security device of claim 11, wherein the control unit generates energy based on the communication signal received through the communication antenna, and generates the encryption key using the generated energy.

17. A security program stored in a medium for performing the steps of:
generating a random number based on a radio frequency (RF) signal from an external electronic device;
generating a private encryption key (Priv_Sender) from the random number;
generating a public encryption key (Pub_Sender) from the private encryption key (Priv_Sender);
generating a first shared encryption key from the private encryption key (Priv_Sender) and the public encryption key (Pub_Receiver) of the external electronic device that receives encrypted data; and
encrypting data with the shared encryption key and transmitting the data together with the public encryption key (Pub_Sender).

18. A security program stored in a medium for performing the steps of:
receiving data encrypted with the shared encryption key according to claim 17 and the public encryption key (Pub_Sender);
generating a second shared encryption key identical to the first shared encryption key from the private encryption key (Priv_Receiver) of the external electronic device and the received public encryption key (Pub_Sender); and
decrypting the encrypted data with the second shared encryption key.
